(19) United States
(12) Patent Application Publication
(10) Pub. No.: US 2010/0025357 A1
(43) Pub. Date: Feb. 4, 2010

(54) CLOSURE

(75) Inventors: Gregor Bruce Yeo Christie, Middle Park (AU); Thi Thuy Tran, Springvale (AU)

Correspondence Address: CONNOLLY BOVE LODGE & HUTZ LLP, 1875 EYE STREET, N.W., SUITE 1100, WASHINGTON, DC, 20006, US

(73) Assignee: PROCORK PTY LTD, Victoria (AU)

(21) Appl. No.: 12/514,816

(22) PCT Filed: Nov. 16, 2007
(86) PCT No.: PCT/AU2007/001766

§ 371 Date: May 26, 2009

(30) Foreign Application Priority Data
Nov. 17, 2006 (AU) AU 2006906423
Nov. 23, 2006 (AU) AU 2006906531
Jan. 19, 2007 (AU) AU 2007900263

(51) Int. Cl. B65D 41/04; B32B 27/08

(52) U.S. Cl. 215/233; 428/446; 428/480; 428/500; 428/523; 428/532; 215/329

(57) ABSTRACT

A deformable composite that composite can be used as a liner in a screw cap or as an interference stopper and which contains one or more film layers to control oxygen permeation characterised in that the inverse of the oxygen permeances of in the individual sections of the deformable composite when added together fall between 300 to 1500 preferably 1250 days.atm/ml. This is calculated using the formula 1/P1+1/P2+1/P3+1/P4 . . . +1/Px=Y Where P is the oxygen permeance of each section of the composite in ml/day 1 to x depicts each individual section of the x sections of the composite Y is between 300 to 1500 preferably 1250 days.atm/ml. In a second aspect the outer closure body is perforated to give the outer body an inverse of the gas permeance less than 300 (days/atm/ml). The formula used is 1/(Pl+Ps) <1/Pob Where P is the oxygen permeance of each section in ml/day I depicts the liner s depicts the seal between the liner and the glass bottle ob depicts outer body.

The present invention relates to an improved method for closing wine bottles. In particular it is applicable to screw cap closures for wine bottles.

### BACKGROUND OF THE INVENTION

Traditionally wine has been stored in bottles sealed with cork closures. More recently screw cap (see U.S. Pat. No. 6,403,173), synthetic cork and now membrane coated cork(see WO03/004367) has been used in place of cork.

Bottle closures require a deformable resilient component that can conform to the surface being seal against and apply some sealing force. This is typically achieved with a foam, fibrous or elastic body that when compressed will provide a opposing force to press against the surface to be sealed. Cork in its various natural, synthetic and hybrid forms and screw cap liners all have a deformable resilient component. In screw cap the seal force is achieved by the compression of the deformable resilient component by the cap being held down by the screw thread. There are membrane corks in the market which have a membrane laminated to the cork. Screw cap liners can be a foam or fibre disc with a laminate coating or they can be a soft polymer/rubber. Screw cap liners for the wine industry are typically of two types. A closed cell foam with a metal foil laminate or a closed cell foam with a polymer liner made of barrier polymer like saranex or non-barrier polymer like polyethylene.

Traditionally the outer body of the screw cap is made of low gas permeance materials that are either complete barriers such as aluminium or very high barrier such as thick plastic such as polyethylene.

The materials used to seal screw cap closures are generally designed to exclude oxygen. European patent 306820 U.S. Pat. Nos. 5,676,178 and 6,677,016 each disclose barrier seals that can be used for closures.

The most recent scientific studies confirm what has been generally accepted for the last 400 years: that oxygen is intimately involved in the aging process of bottled wine. The research has identified that too much oxygen can prematurely oxidise wine, small amounts of oxygen through the closure can accelerate wine development/maturation and that too little oxygen can result in the development of reduced characters in wine. Leading researchers have recently acknowledged that oxygen ingress is actually one of the major factors determining wine development in the bottle and that complete oxygen barrier is not ideal for wine.

The olfactory defect called reduction, evidenced by reduced characters, in wine is a well known phenomenon. It results from sulphur derivatives such as particular sulfides and thiols in the wine. They cause rotten egg, garlic, stagnant water, onion, rubber, burnt rubber, cooked cabbage, earthy, metallic, cauliflower odours. Even at low concentrations these odours are likely to ruin a wine's aroma. More recently wine critics and judges have noticed low level reduced character can effect the palate causing a mineral character and bitterness. Some specific compounds that cause reduction are hydrogen sulphide, methyl mercaptan (aka methanethiol) 2-Mercatoethanol, Methionol.

The causes of reduction are not well understood although some causes are known to be volatile sulphur compounds produced by yeast metabolism, or by vine sprays, or by heat, or by exposure to natural light. More recently post bottling reduction has been linked to screw cap that uses metal liners.

It is an object of this invention to provide a seal for wine bottles that aids in the development of wine flavour through the controlled ingress of oxygen

### BRIEF DESCRIPTION OF THE INVENTION

To this end the present invention provides a deformable composite that composite can be used as a liner in a screw cap or as an interference stopper and which contains one or more film layers to control oxygen permeation characterised in that the inverse of the oxygen permeances of in the individual sections of the deformable composite when added together fall between 300 and 1500 preferably between 500 and 1250 days.atm/ml.

The present invention provides a deformable composite with the properties to provide an exact oxygen permeance range for use with wine in normal wine bottles having an internal neck diameter between 16 and 22 mm.

The present invention provides a composite which can deliver oxygen permeances in this range when incorporated as a liner for screw cap or used as an interference stopper and thereby decrease the amount of oxidation and reduction in wine.

Tables 1, 2 and 3 illustrate the structure and properties of currently available screw cap closures.

TABLE 1
Screw Cap tin liner

| | | Layer 1 | Layer 2 | Layer 3 | Layer 4 | |
|---|---|---|---|---|---|---|
| name | | PE foam | tin foil | PVDC | 0 | |
| Permeability* | | 4500 | 0.001 | 1.5 | 0 | |
| Thickness | micron | 1500 | 0.5 | 2 | 0 | |
| Foam cell dia | micron | 100 | 0 | 0 | 0 | |
| Foam cell wall | micron | 2 | | | 0 | |
| thickness Ave | | | | | | |
| Effective thickness | micron | 30 | 0.5 | 2 | 0 | |
| diameter bottle bore | mm | 18.5 | 18.5 | 18.5 | 0 | |
| permeance | | 0.0201683 | 1.34455E−05 | 0.00504208 | 0.0001 | total |
| 1/permeance | | 49.582752 | 74374.12843 | 198.331009 | 0 | 74622.04 |

*ml 25 micron/m2.atm.day

TABLE 2
Screw Cap Saran liner

| | | Layer 1 | Layer 2 | Layer 3 | Layer 4 | |
|---|---|---|---|---|---|---|
| name | | PE foam | PE | PVDC | PE | |
| Permeability* | | 4500 | 4500 | 1.5 | 4500 | |
| Thickness | micron | 1500 | 10 | 2 | 10 | |
| Foam cell dia | micron | 100 | 0 | 0 | 0 | |
| Foam cell wall | micron | 2 | | | | |
| thickness Ave | | | | | | |
| Effective thickness | micron | 30 | 10 | 2 | 10 | |
| diameter bottle bore | mm | 18.5 | 18.5 | 18.5 | 18.5 | |
| permeance | | 0.020168 | 3.02524554 | 0.005042 | 3.025246 | total |
| 1/permeance | | 49.58275 | 0.33055168 | 198.331 | 0.330552 | 248.5749 |

*ml 25 micron/m2.atm.day

TABLE 3
Screw cap PE liner

| | | Layer 1 | Layer 2 | |
|---|---|---|---|---|
| name | | PE foam | PE | |
| Permeability* | | 4500 | 5000 | |
| Thickness | micron | 1500 | 20 | |
| Foam cell dia | micron | 100 | 0 | |
| Foam cell wall | micron | 2 | | |
| thickness Ave | | | | |
| Effective thickness | micron | 30 | 20 | |
| diameter bottle bore | mm | 18.5 | 18.5 | |
| permeance | | 0.020168 | 1.680692 | total |
| 1/permeance | | 49.58275 | 0.594993 | 50.17775 |

*ml 25 micron/m2.atm.day

In another aspect this invention uses an insight that deformable composites can be used as a liner in a screw cap or as an interference stopper and which contains one or more film layers to control oxygen permeation characterised in that the inverse of the oxygen permeances of in the individual sections of the deformable composite when added together fall between 300 and 1250 days.atm/ml.

These can be used to provide an exact oxygen permeance range for use with wine in normal wine bottles having an internal neck diameter between 16 and 22 mm. None of the current screw cap liners or synthetic cork closures provide oxygen permeances in the range 0.0033 to 0.0008 ml/day.atm.

In a second embodiment this invention provides the outer body of a screw cap to be used with traditional screw cap liners or new oxygen permeable composite liners which can improve the delivery of the oxygen permeances with greater consistency and thereby decrease the amount of oxidation and reduction in wine. The key component of this aspect of the invention relates to the outer body of the screw cap. Specifically the outer body is altered in a way to allow very high or a controllable gas permeances through the cap body. The inverse of the gas permeance of the outer body of the cap is selected to be lower than the addition of the gas permeance of the tin based liner plus the gas permeance of the seal between the liner and the glass bottle. Typically the inverse of the addition of the inverse of the gas permeance of the liner plus the inverse of the gas permeance of seal between the liner and the glass bottle for screw cap is of the order of 1500 (days/atm/ml) and for the liners designed for wine it is between 300 and 1250 (days/atm/ml). The usual practice for wine is to use aluminium for the outer body of the cap. The aluminium itself has an the inverse of the gas permeance being orders of magnitude higher than 1500 (days/atm/ml). The invention here provides an outer body of the aluminiun cap modified to give the outer body an inverse of the gas permeance significantly less than 300 (days/atm/ml).

### DETAILED DESCRIPTION OF THE INVENTION

The key component of this invention relates to screw cap liners and membrane corks. Specifically where the closures deformable resilient component is laminated with a polymer film. A deformable laminated resilient component was invented here, where the inverse of the deformable parts of the component's oxygen permeances added together and to the inverse of the laminated films oxygen permeances added together lies between 300 to 1500 preferably from 500 to 1250 days.atm/ml.

It was shown that this structure provides the optimum closure performance for wine to inhibit negative reduction and negative oxidation characters in the wine.

For clarity

1/P1+1/P2+1/P3+1/P4 . . . +1/Px=Y

Where

P is the oxygen permeance of each section of the composite in ml/day

1 to x depicts each individual section of the x sections of the composite

Y is between 300 to 1500 days.atm/ml.

The particular value selected within the range will be determined by the anticipated oxygen ingress required to obtain the optimum wine flavour development without excessive oxidation or reduction characteristics. This will in part be determined by the grape variety and wine style, bottle size, and expected period for the wine to reach maturity.

The composite can have a number of deformable sections and a number of films laminated to them in groups or singularly. The overall sum of the inverse of the permeances of each component needs to fall in the range 300 to 1500 days.atm/ml.

The deformable sections can be made of foamed, matted fibrous or solid material so long as when deformed it exerts a pressure back onto the surface deforming it. The foam can be open or closed cell. Closed cell is more preferable. The materials can be natural or synthetic. Cork provides a good foam material because it has a low permeance and fine cell structure. Foamed synthetic polymers also provide good material for the deformable section of the invention however the permeance is higher than that of cork.

The laminated film/s of the invention needs to be of low oxygen permeance to provide a composite where the inverses of the permeances of the various components add up to fall in the range 300 to 1500 preferably 500 to 1250 days.atm/ml.

Suitable films include films containing monolayers or combinations of PVDC, Nylon, EAA, EVOH, starch, cellulose, PET, PE, PP, EVA, PEO, polystyrene, polycarbonate, PVC and silicone and co-polymers of the above polymers.

### Example 1

A membrane based closure was prepared where a membrane of permeance 0.0012+/−0.0003 (ml/day) was laminated to a deformable part (closed cell foam body) of permeance 0.004 (ml/day). The membrane was a three layer laminate of PE copolymer/PVDC/Nylon. The foam body was made of natural cork. The inverse of the deformable part of the component's oxygen permeance added to the inverse of the laminate's oxygen permeance is 1080 days/ml.

The following examples set out the structure and permeabilities of other laminates that fall within the scope of this invention.

### Example 2

| | | Layer 1 | Layer 2 | Layer 3 | Layer 4 | |
|---|---|---|---|---|---|---|
| name | | PE foam | Modified PE | PVDC | nylon | |
| Permeability* | | 4500 | 5000 | 1.5 | 30 | |
| Thickness | micron | 1500 | 5 | 3 | 10 | |
| Foam cell dia | micron | 100 | 0 | 0 | 0 | |
| Foam cell wall | micron | 2 | | | | |
| thickness Ave | | | | | | |
| Effective thickness | micron | 30 | 5 | 3 | 10 | |
| diameter bottle bore | mm | 18.5 | 18.5 | 18.5 | 18.5 | |
| permeance | | 0.0201683 | 6.722767857 | 0.00336138 | 0.0201683 | total |
| 1/permeance | | 49.582752 | 0.148748257 | 297.496514 | 49.582752 | 396.8108 |

*ml 25 micron/m2.atm.day

### Example 3

| | | Layer 1 | Layer 2 | Layer 3 | Layer 4 | |
|---|---|---|---|---|---|---|
| name | | PE foam | Modified PE | PVDC | nylon | |
| Permeability* | | 4500 | 5000 | 1.5 | 30 | |
| Thickness | micron | 1500 | 5 | 5 | 10 | |
| Foam cell dia | micron | 100 | 0 | 0 | 0 | |
| Foam cell wall | micron | 2 | | | | |
| thickness Ave | | | | | | |
| Effective thickness | micron | 30 | 5 | 5 | 10 | |
| diameter bottle bore | mm | 18.5 | 18.5 | 18.5 | 18.5 | |
| permeance | | 0.0201683 | 6.722767857 | 0.00201683 | 0.0201683 | total |
| 1/permeance | | 49.582752 | 0.148748257 | 495.827523 | 49.582752 | 595.1418 |

*ml 25 micron/m2.atm.day

### Example 4

| | | Layer 1 | Layer 2 | Layer 3 | Layer 4 | |
|---|---|---|---|---|---|---|
| name | | PE foam | Modified PE | PVDC | nylon | |
| Permeability* | | 4500 | 5000 | 1.5 | 30 | |
| Thickness | micron | 2500 | 5 | 3 | 10 | |
| Foam cell dia | micron | 50 | 0 | 0 | 0 | |
| Foam cell wall | micron | 2 | | | | |
| thickness Ave | | | | | | |
| Effective thickness | micron | 100 | 5 | 3 | 10 | |
| diameter bottle bore | mm | 18.5 | 18.5 | 18.5 | 18.5 | |
| permeance | | 0.012101 | 6.722767857 | 0.00336138 | 0.0201683 | total |
| 1/permeance | | 82.63792 | 0.148748257 | 297.496514 | 49.582752 | 429.8659 |

*ml 25 micron/m2.atm.day

### Example 5

| | | Layer 1 | Layer 2 | Layer 3 | Layer 4 | |
|---|---|---|---|---|---|---|
| name | | PE foam | Modified PE | PVDC | PET | |
| Permeability* | | 4500 | 5000 | 1.5 | 200 | |
| Thickness | micron | 1500 | 5 | 3 | 10 | |
| Foam cell dia | micron | 100 | 0 | 0 | 0 | |
| Foam cell wall | micron | 2 | | | | |
| thickness Ave | | | | | | |
| Effective thickness | micron | 30 | 5 | 3 | 10 | |
| diameter bottle bore | mm | 18.5 | 18.5 | 18.5 | 18.5 | |
| permeance | | 0.0201683 | 6.722767857 | 0.00336138 | 0.1344554 | total |
| 1/permeance | | 49.582752 | 0.148748257 | 297.496514 | 7.4374128 | 354.6654 |

*ml 25 micron/m2.atm.day

### Example 6

| | | Layer 1 | Layer 2 | Layer 3 | Layer 4 | Layer 5 | |
|---|---|---|---|---|---|---|---|
| name | | PE foam | Modified PE | Nylon | EVOH | Nylon | |
| Permeability* | | 4500 | 5000 | 30 | 0.3 | 30 | |
| Thickness | micron | 1500 | 5 | 10 | 2 | 10 | |
| Foam cell dia | micron | 100 | 0 | 0 | 0 | 0 | |
| Foam wall thickness | micron | 2 | | | | | |
| Effective thickness | micron | 30 | 5 | 10 | 2 | 10 | |
| diameter bottle bore | mm | 18.5 | 18.5 | 18.5 | 18.5 | 18.5 | |
| permeance | | 0.0201683 | 6.722767857 | 0.0201683 | 0.0010084 | 0.020168 | to [symbol] |
| 1/permeance | | 49.582752 | 0.148748257 | 49.5827523 | 991.65505 | 49.58275 | 1 [symbol] |

*ml 25 micron/m2.atm.day [symbol]
indicates data missing or illegible when filed

### Example 7

| | | Layer 1 | Layer 2 | Layer 3 | Layer 4 | Layer 5 | Layer 5 | |
|---|---|---|---|---|---|---|---|---|
| name | | PE foam | Modified PE | PVDC | PET | PVDC | PET | |
| Permeability* | | 4500 | 5000 | 1.5 | 200 | 1.5 | 200 | |
| Thickness | micron | 1500 | 5 | 3 | 2 | 3 | 10 | |
| Foam cell dia | micron | 100 | 0 | 0 | 0 | 0 | 0 | |
| Foam wall thickness | micron | 2 | | | | | | |
| Effective thickness | micron | 30 | 5 | 3 | 2 | 3 | 10 | |
| diameter bottle bore | mm | 18.5 | 18.5 | 18.5 | 18.5 | 18.5 | 18.5 | |
| permeance | | 0.0201683 | 6.722767857 | 0.00336138 | 0.6722768 | 0.003361 | 0.134455 | tol [symbol] |
| 1/permeance | | 49.582752 | 0.148748257 | 297.496514 | 1.4874826 | 297.4965 | 7.437413 | 65 [symbol] |

*ml 25 micron/m2.atm.day [symbol]
indicates data missing or illegible when filed

In a second aspect the invention provides an outer body of the aluminiun cap modified to give the outer body an inverse of the gas permeance significantly less than 300 (days/atm/ml). It was shown that this structure provides the optimum closure performance for wine to inhibit negative reduction and negative oxidation characters in the wine.

For clarity 1/(Pl+Ps) <1/Pob

Where P is the oxygen permeance of each section in ml/day

l depicts the liner

s depicts the seal between the liner and the glass bottle

ob depicts outer body

The particular value of 1/Pob is selected will be determined by the anticipated oxygen ingress required to obtain the optimum wine flavour development without excessive oxidation or reduction characteristics. This will in part be determined by the grape variety and wine style, bottle size, and expected period for the wine to reach maturity.

A number of different liners can be used including those that are composites with a number of deformable sections and a number of films laminated to them in groups or singularly. The liner can be made with the deformable sections made of foamed, matted fibrous or solid material so long as when deformed it exerts a pressure back onto the surface deforming it. The foam can be open or closed cell. Closed cell is more preferable. The materials can be natural or synthetic. Cork provides a good foam material because it has a low permeance and fine cell structure. Foamed synthetic polymers can also be used.

A number of outer body materials can be used including aluminium, steel, plastic or wood. The outer body can be modified in a number of ways including additive to increase the porosity or the permeance the material or the use of perforations, or slits or other holes to increase the porosity or the permeance, or the use of windows of breathable material to increase the porosity or the permeance of the outer body. Perforations can be punched out to provide for a wine screw cap with 5 to 10 holes of perforation diameter of 0.5 to 2mm. Using lasers or other methods micro perforations of 50 to 1000 holes of 10 to 500 micron diameter may be used.

### Example 8

A screw cap was prepared made of aluminium with perforations with a permeance of 20,000 (ml/day.atm) and a membrane based liner was prepared with a membrane of permeance 0.0012+/−0.0003 (ml/day.atm). The permeance of the seal between the liner and the glass is 0.0005 (ml/day.atm). The inverse of the permeance of the screw cap's outer body is 0.00005 days.atm/ml which is less than the inverse of the liner's oxygen permeance added to the permeance of the seal between the liner and the glass per which is 588 days.atm/ml.

Those skilled in the art will realize that this invention provides a unique improvement for the bottling and aging of wine in screw cap bottles.

Those skilled in the art will also realize that the invention may be implemented in embodiments other than those disclosed without departing from the core teachings of this invention.

1. A deformable composite that composite can be used as a liner in a screw cap or as an interference stopper and which contains one or more film layers to control oxygen permeation characterised in that the inverse of the oxygen permeances of in the individual sections of the deformable composite when added together fall between 300 to 1500 days.atm/ml.

2. A deformable composite as claimed in claim 1 for use in a screw cap closure for wine bottles wherein
1/P1+1/P2+1/P3+1/P4 . . . +1/Px=Y
Where
P is the oxygen permeance of each section of the composite in ml/day
1 to x depicts each individual section of the x sections of the composite
Y is between 300 to 1250 days.atm/ml.

3. A deformable composite as claimed in claim 2 in which the layers are selected from monolayers or combinations of PVDC, Nylon, EAA, EVOH, starch, cellulose, PET, PE, PP, EVA, PEO, polystyrene, polycarbonate, PVC and silicone and co-polymers of the above polymers.

4. A closure made of aluminium that has been treated to provide to give the outer body an inverse of the gas permeance less than 300 (days/atm/ml).

5. A closure for wine bottles as claimed in claim 4 where in
1/(Pl+Ps) <1/Pob
Where
P is the oxygen permeance of each section in ml/day
l depicts the liner
s depicts the seal between the liner and the glass bottle
ob depicts outer body.
